(19) United States
(12) Patent Application Publication
(10) Pub. No.: US 2002/0122845 A1
(43) Pub. Date: Sep. 5, 2002

(54) Cheese with characteristics of different natural cheeses

(76) Inventors: Kurt Heitmann, Neshkoro, WI (US); Marilynn J. Reichel, Beaver Dam, WI (US)

Correspondence Address: Donald Cayen, Suite 501, 104 South Main Street, Fond du Lac, WI, 54935, US

(21) Appl. No.: 09/795,418

(22) Filed: Mar. 1, 2001

(51) Int. Cl. A23C 9/12

(52) U.S. Cl. 426/36

(57) ABSTRACT

A cheese that has the stringy texture and melt characteristics of young mozzarella cheese, but the appearance of cheddar cheese. The cheese is produced by adding a natural colorant to the vat in which the milk is initially cultured. A modified cheese includes a starter distillate that is added to the enclosed finishing vat (EFV). The modified cheese possesses the texture and melt characteristics of young mozzarella cheese, but it has the color of cheddar and the flavor of butter. Another cheese is comprised of a small percentage of American style cheese added to the curds in either the vat or in the EFV. A preferred American style cheese is cheddar. A starter distillate can also be added to the EFV along with the American style cheese. In all cases, other than adding the mentioned ingredients, the process for making natural mozzarella cheese is followed from start to end.

### BACKGROUND OF THE INVENTION

1. Field of the Invention

This invention pertains cheese and processes for manufacturing cheese, and more particularly to cheese that combines the desirable characteristics of more than one natural cheese.

2. Description of the Prior Art

Numerous federal and state statutes and regulations regulate the production and marketing of cheese. For example, 21 C.F.R. 133 regulates cheese standards at the federal level. In the State of Wisconsin, Statute 97.177 applies to cheesemaking.

A vital aspect of the various cheese-related statutes and regulations is the matter of definitions. Of particular importance are the definitions of what a particular cheese is and how it is to be made. For example, 21 C.F.R. 133.113 describes the ingredients and manufacturing process related to cheddar cheese. 21 C.F.R. 133.155 treats the ingredients and manufacturing processes related to mozzarella cheese. Accordingly, any substance that does not meet a particular definition is not the cheese of that definition.

According to United States International Trade Commission Publication 3080, a natural cheese is one that requires no further processing after being produced. Further, additives are not allowed in any standard of identity natural cheese. That is in contrast to a processed cheese, which is made by grinding, heating, and mixing natural cheese. Example of cheese-like products that are not natural cheeses include processed cheeses in which any of numerous additives are combined with natural cheeses to yield different types of final products. Examples of additives commonly found in processed cheese products include gums, stabilizers, starches, emulsifying agents, dairy solids, and non-dairy isolates. Each of the additives imparts a desired characteristic to the finished product. Gums and stabilizers, for example, produce a specific texture to the finished product, and they also act to bind free water within the product. Emulsifying agents are useful for controlling fat release and protein breakdown. Food starches and non-dairy protein isolates have the ability to change the melt appearance of the cheese product.

A major disadvantage related to additives in cheese is that a combination of additives is normally required to obtain an acceptable finished product that actually has the characteristics claimed for it. U.S. Pat. No. 5,902,625 teaches in some detail some of the various types of additives that can be added to cheese-like products as well as the effects of adding the various additives.

Many commonly used additives add sodium to the finished cheese product. Sodium has frequently been linked to heart disease and hypertension. In addition, the United States Department of Agriculture monitors the sodium content of the food products it purchases for school lunch programs. A cheese-like product with relatively high sodium content may not be acceptable as one of the nutritional components that is balanced for the diets of children. Accordingly, intentionally adding sodium to a cheese product is a dubious way to obtain certain other advantages.

A water binding additive is especially common in cheese-like products. Consequently, consumers are often forced to purchase additional water in order to take advantage of the other cheese-related benefits described for the particular product. The water that is bound to the cheese-like product by one or more of the additives reduces the amount of protein available per serving. Some dairy solid additives contain significant amounts of lactose, a milk sugar to which many persons are allergic.

A further factor disfavoring the use of additives in cheese concerns public opinion. The general public has indicated a positive response to the reduction of additives within the food choices they have available. In the field of natural cheeses, they are often divided into two categories: pasta filata natural cheeses and American style natural cheeses. The term pasta filata as used in this patent includes cheeses that are characterized by a soft but stringy texture and that have good melt characteristics. Such cheeses are well known by the names of mozzarella and provolone. They are commonly used in Italian style cooking to make such foods as pizza and lasagna.

American style cheeses generally have slightly lower moisture content, which gives them a firmer body, than pasta filata cheeses. Common types of American style cheeses include cheddar, colby, and monterey jack. Although eminently suitable and healthy for a wide variety of uses, American style cheeses in general do not have good melt characteristics. In addition, for certain applications such as Mexican foods, many consumers prefer a gold or yellow colored cheese over a white cheese. For example, a color of No. 8 or above on the NCI Cheese Color Standard is preferred for cheese used with Mexican style foods.

Thus, despite the wide variety of natural cheeses presently available, there is room for further refinements to them.

### SUMMARY OF THE INVENTION

In accordance with the present invention, a cheese, and the method of making it, are provided that combine selected desirable characteristics of different natural cheeses. This is accomplished by incorporating selected natural ingredients into a pasta filata cheese.

According to one aspect of the invention, a natural gold or yellow colorant is added to milk in the vat at the start of the process for manufacturing mozzarella cheese. The milk is processed in the manner usual to making the mozzarella. The milk may be whole milk, or it may be part skim, as is well known to persons skilled in the cheesemaking arts. The amount of colorant is selected such that the finished cheese has the appearance of colored cheddar cheese. The color is preferably in the range of about No. 4 to No. 10 of the NCI Cheese Color Standard. The finished cheese is a natural product, having the full flavor, texture, and nutrition of natural mozzarella. Additionally, the finished cheese possesses the desirable melt characteristics of mozzarella that are important for cooking. However, its appearance is that of natural cheddar cheese.

Further in accordance with the present invention, the cheese can have a natural flavorant added to it in addition to the natural colorant. Preferably, the flavorant is in the form of a starter distillate. The starter distillate is added to the enclosed finishing vat (EFV) at salting or just prior to removal to the mixer. The combination of the natural mozzarella cheese with the cheddar color and starter distillate produces a finished cheese that is unique. The finished cheese combines the desirable melt and stringy characteristics of mozzarella with the visual appearance of cheddar and the taste of the particular starter distillate. Like the mozzarella cheese made with just a colorant, the cheese that combines a colorant and a flavorant can be made from either whole milk or part skim milk.

In a modified embodiment of the invention, the cheese is manufactured by combining mozzarella with natural American style cheese. Natural colorant is added to whole or part skim milk in the vat. Also added to the vat is a quantity of up to approximately 25 percent by weight of a selected natural American style cheese. Preferably, the added American style cheese is cheddar. The milk and American style cheese are processed in the same way as natural mozzarella, except that the American style cheese may be made with whole milk. The finished cheese not only has the appearance of cheddar cheese, it also has a pronounced cheddar flavor. On the other hand, the finished cheese substantially retains the melt and stringy characteristics of natural mozzarella.

In some instances, it may be desirable to add the American style cheese in the EFV rather than in the vat. In either case, the finished cheese possesses substantially the same characteristics as the cheese made by adding the American style cheese to the vat.

As a further example of the versatility of the invention, both American style cheese and a starter distillate can be incorporated into the process of making natural mozzarella. The whole or part skim milk, as the case may be, is colored as described previously.

The cheese and method of the invention, using a natural colorant with or without a flavorant and with or without a natural American style cheese, thus provides consumers with a novel and healthy cheese free of non-natural additives. The cheese has the color of cheddar, and, depending on the optional addition of American style cheese, also the flavor of cheddar, even though the cheese is manufactured like natural mozzarella.

Other advantages, benefits, and features of the present invention will become apparent to those skilled in the art upon reading the detailed description of the invention.

### BRIEF DESCRIPTION OF THE DRAWINGS

FIG. 1 is a simplified schematic diagram of the process and equipment for making natural mozzarella cheese, but showing the modification for making the cheese of the invention.

FIG. 2 is a simplified schematic diagram of the process and equipment for making natural mozzarella cheese, but showing the modifications for making a modified cheese according to the invention.

FIG. 3 is a simplified schematic diagram of the process and equipment for manufacturing a further modified cheese according to the invention.

FIG. 4 is a diagram similar to FIG. 3, but showing an alternate method of making the further modified cheese of the invention.

FIG. 5 is a simplified schematic diagram of the process and equipment for making an alternate embodiment of the cheese of the invention.

### DETAILED DESCRIPTION OF THE INVENTION

Although the disclosure hereof is detailed and exact to enable those skilled in the art to practice the invention, the physical embodiments herein disclosed merely exemplify the invention, which may be embodied in other specific structure. The scope of the invention is defined in the claims appended hereto.

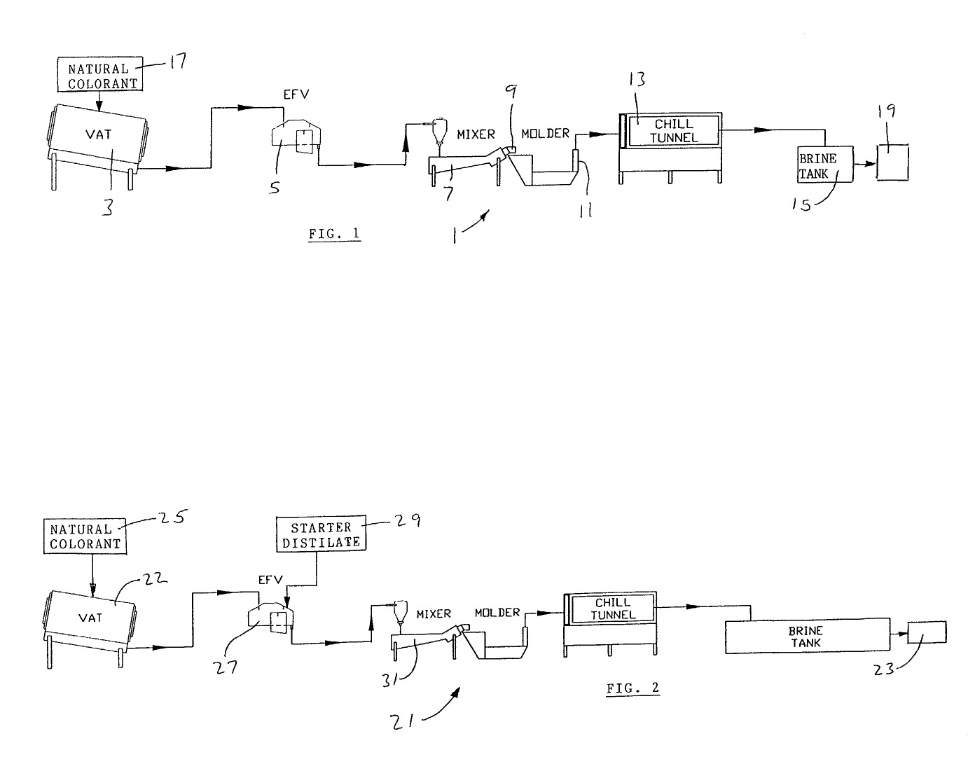

Referring to FIG. 1, reference numeral 1 indicates an installation of various pieces of equipment used in the manufacture of natural pasta filata cheese, such as mozzarella. Briefly, reference numeral 3 represents a vat into which previously pasteurized milk is pumped. The milk may be whole milk, in which case the finished mozzarella cheese would have a minimum of 45 percent fat on a dry basis as governed by Title 21 of the Code of Federal Regulations. Alternately, the milk may be partially skimmed, in which case the finished cheese would have between 30 percent and 45 percent fat on a dry basis. A starter culture and rennet are added to the milk in the vat 3. The starter may be made up of streptococcus thermophilus, lactobacillus delbrueckii, or lactobacillus helveticus. The starter may be a blend of the foregoing, or used individually. One source of the starter bacteria is Chr. Hansen, Inc., of Milwaukee, Wis. That company is also a source of rennet.

The starter and rennet cause the milk to coagulate, which is then cut into curds. After the curds have been cooked and stirred the desired amount, some of the whey is removed. The remainder of the curds and whey are pumped to an enclosed finishing vat (EFV) 5. There the curds are further stirred, and additional whey is drawn off. The curds are washed and salted. The curds are then transferred to a mixer 7, where they are melted by hot water. The molten curds are extruded through one or more tubes 9, which gives mozzarella its characteristic stringy texture. The extruded cheese is packed in molds 11 and sent to a chill tunnel 13. The cool and firm blocks of cheese are removed from the molds 11 and deposited in a brine solution 15. Finally, the blocks are packaged in the desired way and put in cold storage. The resulting mozzarella cheese is an entirely natural product. It has a characteristic white color, and a taste and texture peculiar to the amount of fat in the milk originally pumped into the vat 3 as well as to the starter culture.

In accordance with the present invention, the characteristic white color of natural mozzarella as manufactured by the normal process is replaced by the yellowish color of a natural cheddar cheese. The cheddar color in the mozzarella cheese is obtained by adding a natural colorant 17 to the vat 3 at the time the pasteurized milk is pumped into the vat. A preferred source of the yellowish color is annatto, which is also commonly used as the colorant for natural colby and cheddar cheeses. The amount of annatto or other colorant is preferably between approximately 0.5 ounces and 3 ounces per 1,000 pounds of milk. One source of the colorant is Chr. Hansen, Inc., of Milwaukee, Wis. In all other respects, the process for making the finished cheese 19 is identical to the process for making natural mozzarella as outlined above and as well known in the art. The finished cheese 19 may be further processed, if desired, such as shredding, before it is packaged and shipped to the end user.

The finished cheese 19 may have the moisture content of low moisture mozzarella (45 percent to 52 percent moisture), or it may have the moisture content of normal moisture mozzarella (52 percent to 60 percent moisture). The final cheese 19 is identical to natural mozzarella except that the finished cheese is the color of colored cheddar (No. 4 to No. 10 on the NCI color chart) rather than naturally white. The cheese of the invention thus possesses all the desirable flavor and other characteristics of mozzarella, such as its desirable melting characteristics, but it also has the attractive yellowish color of natural cheddar cheese. The cheddar appearance is highly desired by many consumers, whether they eat the cheese 19 in the solid state or in the melted state. The finished cheese 19 thus serves as a cheddar alternative, having the appearance of cheddar but the low sodium as compared to processed cheese, high protein, and lesser fat release in cooking of natural mozzarella alternates.

Further in accordance with the present invention, cheese made generally according to the process for making natural mozzarella can have both a cheddar color and a cheddar flavor. Turning to FIG. 2, an installation 21 for making natural mozzarella is shown. Pasteurized whole or part skim milk is pumped into the vat 22. A natural colorant 25, such as annatto, is added to the milk. The starter culture and rennet are added to the milk in the usual manner. After much of the whey has been drawn off, the curds and remaining whey are pumped to the EFV 27.

After the remainder of the whey has been removed, a starter distillate 29 is added to the curds in the EFV. The starter distillate 29 may be in either liquid or powder form. A particularly desirable starter distillate 29 is one that provides a butter flavor. A suitable starter distillate is marketed by Gamay Flavors of New Berlin, Wis. A preferred quantity of starter distillate is between approximately 0.05 percent and 0.15 percent by weight of the finished cheese 23. Another satisfactory source of starter distillate is Chr. Hansen, Inc., which is used at a rate of approximately one to two grams per pound of curd. Preferably, the starter distillate is added to the salt in the EFV. In the EFV 27, the starter distillate 29 is thoroughly mixed with the curds and whey to impart the butter flavor. The curds are mixed, extruded, molded, chilled, and brined in the usual way for natural mozzarella cheese. The finished cheese 23 possesses all the usual characteristics of natural mozzarella, such as its stringiness, fat content, and moisture content, but it also has the color characteristics of natural cheddar plus a buttery taste. As mentioned, the finished cheese 23 may be either full fat or reduced fat depending on whether whole or part skim milk was used in the vat 22.

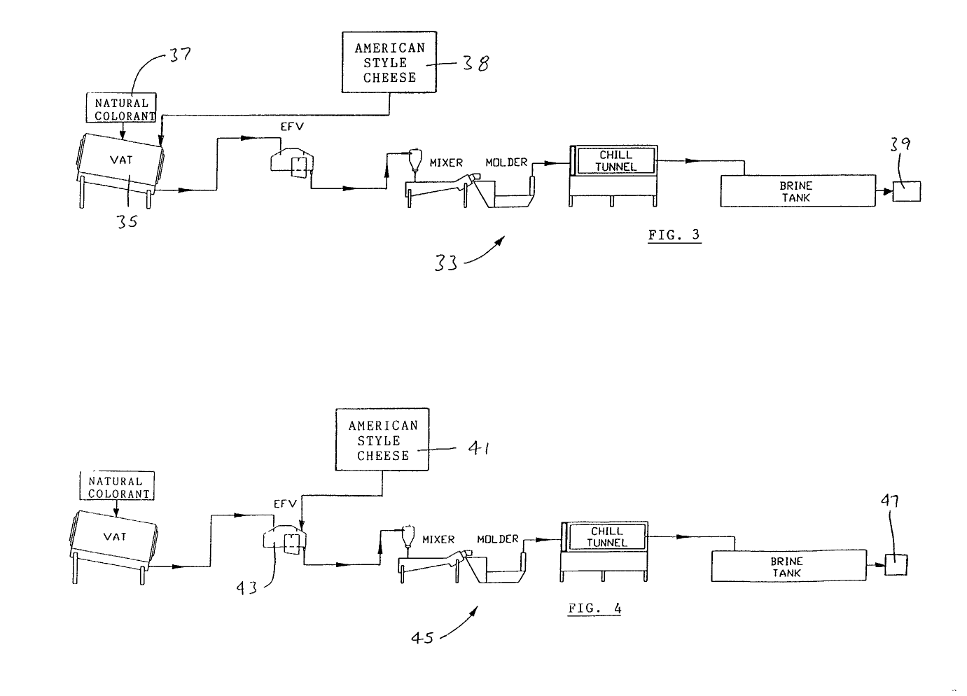

Now turning to FIG. 3, an installation 33 of natural mozzarella cheesemaking equipment is substantially identical to the installations 1, 21, and 21′ described previously. Whole or part skim pasteurized milk is pumped into the vat 35. Natural annatto colorant 37 is also added to the vat 35. In addition, a quantity of natural American style cheese 38 is added to the vat 35. The American style cheese may be added at any time after the milk coagulum has been cut. The American style cheese 38 may be shreds or fines. Suitable American style cheeses are cheddar, colby, and montery jack. However, we prefer that the American style cheese be cheddar. The quantity of American style cheese is between approximately one percent and 25 percent, with the preferred quantity being between approximately five percent and ten percent by weight of the finished cheese 39. After the colorant 37 and American style cheese 38 have been added to the vat, the remainder of the cheesemaking process is identical to the process for making natural mozzarella cheese. Adding the American style cheese at the upstream end of the mozzarella making process maximizes its ability to impart its color and flavor to the milk and curds in the vat. In particular, early addition of the American style cheese allows it to add its natural flavor to the new mozzarella cheese curds by means of the bacterial action of the starter cultures used to make the American style cheese. Cultures used for American Style cheeses are lactic acid producers, usually lactococcus lactis subsp. cremoris or lactococcus lactis subsp. lactis. One source of such cultures is Chr. Hansen. A further advantage of the present invention is that, unlike some prior processes, including those of the U.S. Pat. No. 5,902,625 patent, undried American style cheese is suitable for adding to the natural mozzarella. The color and flavor of the American style cheese carries through the rest of the mozzarella making process. The resulting finished cheese 39 has unique characteristics of a blend of natural mozzarella and cheddar, with the color and flavor of cheddar but the cooking properties of mozzarella.

In FIG. 4, American style cheese 41 is added to the EFV 43 of mozzarella cheesemaking equipment 45. The kinds and properties of the American style cheese 41 may be the same as those used to make the finished cheese 39 of FIG. 4. Adding the American style cheese 41 to the EFV 43 is preferred, because the integration of the American style cheese into the mozzarella curds, plus the recovery of the American style cheese, is then optimized. American style cheese may be added to the EFV at any time after or during pumpover of curd and whey from the make vat. The resulting finished cheese 47 is substantially identical to the finished cheese 39 described previously in connection with FIG. 3.

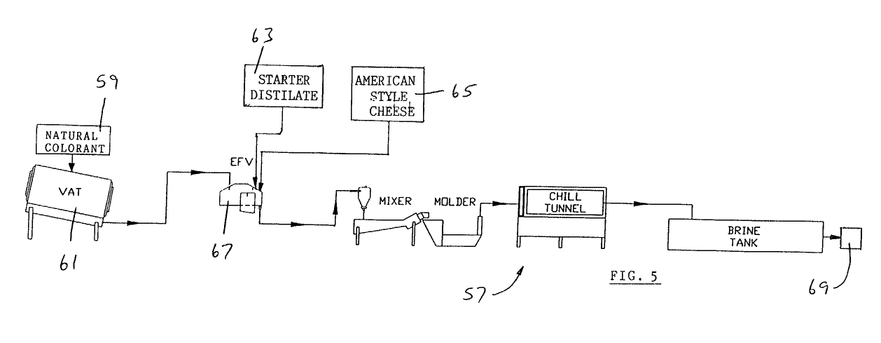

FIG. 5 shows an installation 57 of equipment for making natural mozzarella cheese. Natural annatto colorant 59 is added to the vat 61 as described previously. Both a starter distillate 63 and a quantity of American style cheese 65 are added to the EFV 67. The kinds and quantities of the starter distillate 63 and American style cheese 65 may be as described previously. The finished cheese 69 possesses a unique blend of color, flavor, texture, and cooking characteristics unlike any other cheese, whether natural or processed.

In summary, the results and advantages of different natural cheeses can now be more fully realized. The present invention provides both cheese alternatives to consumers that were not previously available, as well as new methods of making cheese. This desirable result comes from using the combined functions of the natural colorant, such as a colorant used with cheddar cheese, together with mozzarella cheese. The colorant gives natural mozzarella a cheddar appearance without affecting any of the other characteristics of the natural mozzarella. As a further choice, the cheese of the invention can include a starter distillate that provides a desired flavor, such as butter, to a cheese that is made in the manner of natural mozzarella. When used with a natural colorant, the resulting cheese product has the appearance of cheddar and the flavor of butter despite the fact that it melts and has the texture of mozzarella. Relatively small amounts of a natural American style cheese, such as cheddar, can be added with the colorant to cheese made according to the mozzarella process. The American style cheese further contributes to giving the resulting cheese cheddar-like qualities. Using a starter distillate with the American style cheese and colorant produces a further option of a cheese that is manufactured primarily as a mozzarella cheese.

It will also be recognized that in addition to the superior characteristics of the cheese of the invention, its cost is only minimally more than the cost of natural mozzarella cheese. In fact, because of the anticipated consumer acceptance of the invention, increased production is expected to negate any increase in ingredient cost.

Thus, it is apparent that there has been provided, in accordance with the invention, a cheese with characteristics of different natural cheeses that fully satisfies the aims and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

We claim:

1. A cheese having the appearance and flavor of cheddar cheese and the melt and stringiness characteristics of young mozzarella cheese, the cheese consisting of a uniform blend of from approximately 75 percent to 99 percent by weight of a young natural mozzarella cheese, approximately one percent to 25 percent by weight of a natural cheddar cheese, and from approximately 0.5 ounces to 3 ounces of a selected colorant per 1,000 pounds of milk from which the mozzarella cheese is made.

2. The cheese of claim 1 wherein the cheddar cheese is in the form of shreds or fines prior to blending the cheddar cheese into the cheese.

3. The cheese of claim 1 wherein the cheese product consists of from approximately 90 percent to 95 percent by weight of a young natural mozzarella cheese and from approximately five percent to ten percent by weight of a natural cheddar cheese.

4. A cheese having the appearance of cheddar cheese and the melt and stringiness characteristics of young mozzarella cheese, the cheese consisting of a uniform blend of from approximately 75 percent to 99 percent by weight of a young natural mozzarella cheese, from approximately one percent to 25 percent by weight of a natural cheddar cheese, from approximately 0.5 ounces to 3 ounces of a selected colorant per 1,000 pounds of milk from which the mozzarella cheese is made, and from approximately 0.05 percent to 0.15 percent by weight of a selected starter distillate.

5. The cheese of claim 4 wherein the cheddar cheese is in the form of shreds or fines prior to blending the cheddar cheese into the cheese.

6. The cheese of claim 4 wherein the cheese consists of from approximately 90 percent to 95 percent by weight of a young natural mozzarella cheese and from approximately five percent to ten percent by weight of a natural cheddar cheese.

7. The cheese of claim 6 wherein the starter distillate has a butter flavor,
so that the cheese has the appearance of a cheddar cheese, a butter flavor, and the texture and melt characteristics of young mozzarella cheese.

8. A cheese having the texture and melt characteristics of young mozzarella cheese, the color of cheddar cheese, and a butter-like flavor consisting of from approximately 0.5 ounces to 3 ounces of a selected colorant that produces a cheddar color to the cheese product per 1,000 pounds of milk from which a natural mozzarella cheese is made, and from approximately 0.05 percent to 0.15 percent by weight of a selected starter distillate that produces a butter flavor in the cheese.

9. A method of manufacturing a cheese comprising the steps of:
a. pumping pasteurized milk into a vat;
b. adding to and mixing into the milk in the vat a predetermined quantity of a selected natural colorant;
c. adding a starter culture and a rennet to the milk in the vat and thereby producing curds and whey;
d. transferring the curds with the colorant and a portion of the whey to an enclosed finishing vat (EFV);
e. adding a predetermined quantity of a selected starter distillate to the curds and whey in the EFV;
f. transferring the curds with the colorant and the starter distillate to a mixer;
g. melting the curds with the colorant and the starter distillate in the mixer;
h. extruding the melted curds with the colorant and the starter distillate through at least one tube and thereby producing a cheese with a stringy texture characteristic of young mozzarella cheese;
i. molding the cheese into blocks;
j. cooling the cheese blocks in a brine; and
k. removing the blocks from the brine,
so that the cheese has the texture and melt characteristics of a young mozzarella cheese, the appearance imparted by the selected colorant, and the flavor imparted by the selected starter distillate.

10. The method of claim 9 wherein the step of adding a natural colorant comprises the step of adding a natural colorant that imparts the appearance of cheddar cheese to the cheese.

11. The method of claim 9 wherein the step of adding a starter distillate comprises the step of adding a starter distillate that imparts the flavor of butter to the cheese.

12. The method of claim 9 wherein:
a. the step of adding a natural colorant comprises the step of adding between approximately 0.5 ounces and 3 ounces per 1,000 pounds of milk pumped into the vat; and
b. the step of adding a starter distillate comprises the step of adding between approximately 0.05 percent and 0.15 percent by weight of a starter distillate that imparts a butter flavor to the curds,
so that the cheese has the appearance of cheddar cheese and a butter flavor.

13. A method of making a cheese comprising the steps of:
a. pumping pasteurized milk into a vat;
b. adding to and mixing into the milk in the vat a predetermined quantity of a selected natural colorant;
c. adding starter culture and a rennet to the milk in the vat and thereby producing curds and whey;
d. adding to and mixing into the curds and whey in the vat a predetermined quantity of a selected natural American style cheese;
e. transferring the curds with the colorant and the American style cheese and a portion of the whey to an enclosed finishing vat;
f. transferring the curds with the colorant and the American style cheese to a mixer;
g. melting the curds with the colorant and the American style cheese in the mixer;
h. extruding the melted curds with the colorant and the American style cheese through at least one tube and thereby producing a cheese product with a stringy texture;
i. molding the cheese into blocks;
j. cooling the blocks in a brine; and
k. removing the blocks from the brine,
so that the cheese has the characteristics of a blend of natural mozzarella and the selected American style cheese with the color and flavor of the American style cheese but the cooking properties of mozzarella cheese.

14. The method of claim 13 wherein:
a. the step of adding a natural colorant comprises the step of adding between approximately 0.5 ounces and 3 ounces per 1,000 pounds of milk pumped into the vat of a natural colorant that imparts a cheddar color to the milk in the vat; and
b. the step of adding a predetermined quantity of a selected American style cheese comprises the step of adding between approximately one percent and 25 percent by weight of a natural cheddar cheese to the vat,
so that the cheese has the appearance and flavor characteristics of cheddar cheese.

15. The method of claim 14 wherein the step of adding a predetermined quantity of a selected American style cheese comprises the step of adding between approximately five percent and ten percent by weight of a natural cheddar cheese to the vat.

16. A method of making a cheese comprising the steps of:
a. pumping pasteurized milk into a vat;
b. adding to and mixing in the milk in the vat a predetermined quantity of a selected natural colorant;
c. adding a starter culture and a rennet to the milk in the vat and thereby producing curds and whey;
d. transferring the curds with the colorant and a portion of the whey to an enclosed finishing vat (EFV);
e. adding to and mixing into the curds in the enclosed finishing vat a predetermined quantity of a selected American style cheese;
f. transferring the curds with the colorant and the American style cheese to a mixer;
g. melting the curds with the colorant and the American style cheese in the mixer;
h. extruding the melted curds with the colorant and the American style cheese through at least one tube and thereby producing a cheese with a stringy texture;
i. molding the cheese into blocks;
j. cooling the blocks in a brine; and
k. removing the blocks from the brine,
so that the cheese has the texture and melt characteristics of a young mozzarella cheese, and the appearance and flavor of cheddar cheese.

17. The method of claim 16 wherein:
a. the step of adding a natural colorant comprises the step of adding between approximately 0.5 ounces and 3 ounces per 1,000 pounds of milk pumped into the vat of a natural colorant that imparts a cheddar color to the milk in the vat; and
b. the step of adding a predetermined quantity of a selected American style cheese comprises the step of adding between approximately one percent and 25 percent by weight of a natural cheddar cheese to the vat,
so that the cheese has the appearance and flavor characteristics of cheddar cheese.

18. The method of claim 17 wherein the step of adding a predetermined quantity of a selected American style cheese comprises the step of adding between approximately five percent and ten percent by weight of a natural cheddar cheese to the vat.

19. The method of claim 16 comprising the further step of adding between approximately 0.05 percent and 0.15 percent by weight of a starter distillate to the EFV that imparts a butter flavor to the curds in the EFV.
